(19) United States
(12) Patent Application Publication
(10) Pub. No.: US 2026/0330910 A1
(43) Pub. Date: Oct. 22, 2026

(54) SENSOR AND METHOD FOR CHECKING VALUABLE DOCUMENTS HAVING AT LEAST ONE REFLECTIVE SECURITY ELEMENT

(71) Applicant: GIESECKE+DEVRIENT CURRENCY TECHNOLOGY GMBH, Munchen (DE)

(72) Inventors: Thomas HAPP, Munchen (DE); Wolfgang RAUSCHER, Parkstetten (DE)

(21) Appl. No.: 18/993,792

(22) PCT Filed: Jul. 12, 2023
(86) PCT No.: PCT/DE2023/100521

§ 371 Date: Jan. 13, 2025

(30) Foreign Application Priority Data
Jul. 14, 2022 (DE) 10 2022 002 581.7

(51) Int. Cl. G07D 7/00; G07D 7/1205

(52) U.S. Cl. CPC G07D 7/003; G07D 7/1205

(57) ABSTRACT

A sensor and a method are for checking valuable documents having at least one reflective security element which, in the visible spectral range, has an appearance that depends on a viewing angle. The sensor has an irradiation device designed to irradiate one or more different locations on a valuable document with infrared radiation; a detection device designed to detect the infrared radiation reflected from the different locations on the valuable document in each case, the sensor recording a reflectance spectrum from each location; and a checking device which is designed to determine of each reflectance spectrum, whether there is a reflective security element having an appearance that depends on the viewing angle at each location to determine one or more of the locations at which such a reflective security element is located on the valuable document and to check the valuable document based on the location or locations determined.

The invention relates to a sensor and a method for testing valuable documents comprising at least one reflective security element that in the visible spectral range has an appearance that depends on a viewing angle.

To provide better protection against counterfeiting, valuable documents, in particular banknotes, are provided with what are known as optically variable (OV) security elements, for example in the form of film elements, so-called patches, wide security threads or printed-on, magnetically aligned interference pigments, which are reflective. For example, in diffuse reflection, they have an appearance that depends on the viewing angle, and hence they can be tested with the naked eye by simply tilting the valuable document. In addition to holograms and micromirrors, film-based OV security elements also use stacks of thin layers in order to bring about angle-dependent interference colors or color changes.

The problem addressed by the present invention is that of allowing reliable machine-based testing of valuable documents, in particular banknotes, provided with reflective, e.g. optically variable, security elements.

This problem is solved by a sensor and a method for testing valuable documents as per the independent claims, and by a valuable document processing system having such a sensor.

According to a first aspect of the present disclosure, a sensor for testing valuable documents comprising at least one reflective security element that, in particular in the visible spectral range, has an appearance that depends on a viewing angle comprises: an irradiation device configured to irradiate one or more different locations on a valuable document with infrared radiation; a detection device configured to capture the infrared radiation diffusely reflected from the respective location on the valuable document, the sensor being configured to capture the diffusely reflected infrared resolution in spectrally resolved fashion, with a respective diffuse reflectance spectrum being obtained; and a testing device for testing the valuable document in view of a reflective security element that has an appearance that depends on the viewing angle, the testing device being configured to use the diffuse reflectance spectrum obtained for the respective location to ascertain whether a reflective, in particular optically variable, security element with an appearance that depends on the viewing angle is situated on the valuable document at the respective location in order to ascertain one or more locations at which such a (i.e. with an appearance that depends on the viewing angle) reflective security element (the same or optionally different ones) is situated and in order to test the valuable document on the basis of the ascertained location or locations (in view of a reflective security element with an appearance that depends on the viewing angle).

According to a second aspect of the present disclosure, a method for testing valuable documents comprising at least one reflective security element that, in particular in the visible spectral range, has an appearance that depends on a viewing angle includes the following steps: irradiating one or more different locations on a valuable document with infrared radiation and capturing, with spectral resolution, the infrared radiation diffusely reflected from the respective location on the valuable document, with a diffuse reflectance spectrum being obtained in each case; using the diffuse reflectance spectrum obtained for the respective location to ascertain whether a reflective, in particular optically variable, security element with an appearance that depends on the viewing angle is situated on the valuable document at the respective in order to ascertain one or more locations at which such a (i.e. with an appearance that depends on the viewing angle) reflective security element is situated; and testing the valuable document on the basis of the ascertained location or locations for which a reflective, in particular optically variable, security element (with an appearance that depends on the viewing angle) was ascertained as being situated on the valuable document at the respective location.

A third aspect of the present disclosure relates to a valuable document processing system having at least one sensor as per the first aspect of the present disclosure and one or more processing apparatuses that are configured to process valuable documents, in particular to separate out, transport, test, sort, stack and/or destroy valuable documents.

A fourth aspect of the present disclosure relates to a computer program comprising commands which, when the program is executed by a computer, prompt the latter to carry out the method as per the second aspect of the present disclosure. A fifth aspect of the present disclosure relates to a computer-readable data carrier, on which the computer program as per the fourth aspect of the present disclosure is stored. A sixth aspect of the present disclosure relates to a data carrier signal which transfers the computer program as per the fourth aspect of the present disclosure.

Aspects of the present disclosure are preferably based on the approach of performing a respective spectrally resolved measurement of the infrared radiation diffusely reflected from a respective location at a plurality of different locations on a valuable document to be tested, the said locations also being referred to as “measurement locations”, “measurement pixels” or “pixels” in the context of the present disclosure, and of using the diffuse reflectance spectra obtained in the process to identify the location or locations on the valuable document at which such a reflective or optically variable security element is present or identify which locations are situated on a reflective or optically variable security element. To this end, the diffuse reflectance spectrum obtained in each case is analyzed, for example in respect of its spectral curve and/or other properties. A diffuse reflectance spectrum within the meaning of the present disclosure can be a spectrum containing diffuse reflectance values at a plurality of different wavelengths, optionally even at a multiplicity of different wavelengths, or else at only a few different wavelengths, for example at two or three different wavelengths.

The use of infrared radiation for testing a security element that in the visible spectral range has an appearance that depends on a viewing angle offers numerous advantages over a (machine-based) test using visible light: There is better protection against counterfeiting since the infrared signature of the security element cannot be inferred from its visual appearance. The protection against counterfeiting is further increased since the test is implemented using non-visible light, and might therefore remain unnoticed by a potential counterfeiter. Moreover, the test is more reliable since a test using infrared light is impaired to a lesser extent than a test using visible light should the banknote to be tested be dirtied.

The reflective security element that in the visible spectral range has an appearance that depends on a viewing angle is e.g. an optically variable security element, in particular an optically variable security element having a viewing angle-dependent color change. The reflective security element that in the visible spectral range has an appearance that depends on a viewing angle can be both a specularly reflective (with directed or mirror-like reflection) security element and a diffusely reflecting security element.

The infrared radiation diffusely reflected from the respective location and captured by the detection device can be specularly and/or diffusely reflected infrared radiation of the valuable document. By preference, the irradiation device and the detection device are arranged such that the detection device captures diffusely reflected infrared radiation of the valuable document but no specularly reflected infrared radiation.

By preference, there is a test as to whether the location or locations ascertained in this way meets or meet at least one predetermined test criterion, for example in terms of their number and/or their positions on the valuable document. Should this criterion be satisfied, the presence of such a reflective or optically variable security element, optionally with specific properties, is acknowledged and/or the valuable document is classified as “authentic” or “fit” (acceptable state).

An ascertained location at which such a reflective security element is situated can be—in the event of a correspondingly large detection region-a single location which e.g. encompasses the entire area of the relevant security element. However, an ascertained location at which such a reflective security element is situated can also be (in the event of a correspondingly smaller detection region) one of several locations located on the relevant security element. These locations can, but need not, be subject to the spectrally resolved capture or the above-described test on the basis of their diffuse reflectance spectrum. The ascertained locations that are subject to the above-described test or at which such a reflective or optically variable security element is situated can all be located on the same reflective or optically variable security element of the respective valuable document or on different such reflective or optically variable security elements of the respective valuable document.

By preference, exactly one diffuse reflectance spectrum is recorded for the respective location. In particular, a respective diffuse reflectance spectrum is recorded at a plurality of locations on the respective valuable document, with preferably exactly one diffuse reflectance spectrum being recorded at each of the locations.

Knowledge of the specific design and/or specific properties of the respective valuable document to be tested, for instance the expected position of such a reflective or optically variable security element on the valuable document, and the inclusion thereof in the test is not absolutely necessary when using the respectively obtained diffuse reflectance spectrum to ascertain the location or locations at which such a reflective or optically variable security element is situated on the valuable document. In particular, a so-called adaptation of the sensor or method to these properties is not absolutely necessary as a result. Moreover, knowledge of the denomination and orientation of the respective valuable document to be tested is not absolutely necessary when testing the valuable document. Then again, it is self-evident that an even more reliable identification of the relevant locations and/or test of the valuable document can be achieved if specific properties of the valuable document, in particular in view of the position and/or size of the reflective or optically variable security element or the denomination and orientation of the valuable document, are additionally taken into account in the process.

The described approach for identifying the locations located on such a reflective or optically variable security element is based on the surprising insight that many reflective security elements, e.g. interference-based OV security elements, (both based on films and based on printing pigments) intrinsically have specific spectral signatures not only in the visible spectral range (in which OV security elements are primarily tested) but also in the infrared (IR) spectral range. Hence, these can be used for a machine-based test of the OV security elements in the IR. In the process, it is advantageously even possible to use sensors that were developed for or are used for a spectral measurement of IR absorption pigments should the signal evaluation or test used in that case be adapted to the peculiarities of the spectral identification of interference colors.

Overall, the present disclosure thus enables a reliable and simple machine-based test of valuable documents that are provided with one or more reflective or optically variable security elements with an appearance that depends on the viewing angle, in particular of such banknotes.

In principle, the approach disclosed in the present case is suitable for testing or verifying reflective security elements with an appearance that depends on the viewing angle, but it is particularly suitable for testing or verifying optically variable security elements that have e.g. a viewing angle-dependent color change which is created by interference at thin layers, for example. The optically variable security element can be present in the form of an optically variable film element (e.g. what is known as a film patch or a film strip), an optically variable (wide) security thread or an optically variable printing feature (e.g. with interference pigments that, before curing, are magnetically aligned during the printing).

The sensor is configured for the spectrally resolved capture of the infrared radiation diffusely reflected from the respective location. For example, the detection device itself can be configured to spectrally decompose and, in spectrally resolved fashion, capture the diffusely reflected infrared radiation. In that case, the spectral resolution is located on the detection side, and the irradiation device preferably has a broad spectral bandwidth in the infrared. In an alternative and particularly preferably, however, the detection device is a (simpler) detection device that is not designed for the spectral decomposition of light, e.g. of the diffusely reflected infrared radiation. The spectral resolution is then brought about by the successive irradiation of the respective location with infrared radiation at at least two or at least three different wavelengths/wavelength ranges and a corresponding successive detection by means of the detection device at (at least approximately) the same location.

In particular, the configuration and/or arrangement of the detection device is such that the infrared radiation diffusely reflected from the different locations at a (perpendicular or oblique) detection angle is captured, and the irradiation device is configured and/or arranged to direct the infrared radiation at the valuable document such that said infrared radiation is incident on the valuable document at a (perpendicular or oblique) angle of incidence. Should the radiated-in infrared radiation or the captured infrared radiation have an angle variation, the mean angle of the respective angle distribution is considered to be the angle of incidence and detection angle, respectively. By preference, either the angle of incidence or the detection angle is oriented perpendicular to the valuable document and the respective other angle is oriented obliquely thereto.

By preference, the detection angle and the angle of incidence have different magnitudes. Non-observance of the law of reflection (magnitude of the angle of reflection=magnitude of the angle of incidence) during the measurement at the different locations thus is preferred in order to enable an even more reliable identification of the locations located on such a reflective or optically variable security element Thus, a geometry that preferably precisely does not satisfy the conventional reflection condition is advantageously chosen for the irradiation of the valuable document using infrared radiation and for the detection of the infrared radiation diffusely reflected by the valuable document since this leads to fewer artifacts arising at individual wavelengths as a result of what is known as specular reflection (directed reflection or mirror-like behavior). For instance, reflection OV elements, despite frequently making use of micromirror arrays, the tilt of which brings about moving images or patterns, are not subject to disturbances (e.g. overload of the detection device) in the measurement, and there is precisely no need for an exact orientation of the bank note vis-à-vis the sensor. Instead, micromirrors or surface regions of such an OV security element which statistically are always just suitably aligned contribute to the signal, and so a reliable measurement is possible even for creased or bent bank notes. Such a diffuse reflectance measurement already supplies characteristic and stable signals even for a sensor with only a few spectral sampling points (i.e. measurement wavelengths), and it was surprisingly found that these signals can be used for a reliable bank note test.

By preference, the detection angle and/or the angle of incidence is substantially the same for all locations on the valuable document from where the respective diffusely reflected infrared radiation is captured.

By preference, the infrared radiation is directed at the valuable document by the (optionally only one) illumination device at (exactly or approximately) a single angle of incidence, this holding true for all wavelengths in particular, and/or captured by the (optionally only one) detection device at (exactly or approximately) a single detection angle, this holding true for all wavelengths in particular.

By preference, the testing device of the sensor is configured to use only infrared radiation directed at the valuable document at (exactly or approximately) a single angle of incidence and captured from (exactly or approximately) a single detection angle for the ascertainment of the location or locations on the respective valuable document at which such a reflective security element is situated on the valuable document. In other words, the reflection behavior of the valuable document is preferably captured under only one (single) angle condition, i.e. under a single detection angle and a single angle of incidence, at the different locations. It was surprisingly found that many reflective security elements with an appearance that depends on the viewing angle, in particular those with a viewing angle-dependent color change, already have a characteristic signature in the infrared spectral range, which allows them to be reliably identified, in a single measurement under a uniform angle condition. It is therefore possible to manage without repeated testing under different angles of incidence and/or detection angles. Therefore, the sensor can be produced with correspondingly less outlay, e.g. with only a single irradiation device and/or with a single detection device. Moreover, no movable parts are provided, whereby fastmoving valuable documents can also be measured and whereby there is no wear on account of mechanical motion.

It is also considered to be approximately a single angle of incidence if slightly different angles of incidence are present, in particular with a variation of no more than +/−15°, preferably no more than +/−12°, on account of the beam divergence of the irradiation device. It is also considered to be approximately a single detection angle if the aperture of the detection device allows for slightly different detection angles, in particular with a variation of no more than +/−18°, preferably no more than +/−10°.

It is also considered to be approximately a single angle of incidence if the irradiation device comprises a plurality of (e.g. spectrally different) IR light sources that are immediately adjacent to one another or arranged so closely next to one another that they direct their infrared radiation at the valuable document at approximately the same angle of incidence (in particular with a variation of at most+/−5°, preferably at most+/−1°). It is also considered to be approximately a single detection angle if the detection device comprises a plurality of discrete detection elements that are arranged so closely next to one another that they capture the diffusely reflected infrared radiation from the valuable document at approximately the same detection angle (in particular with a variation of at most+/−5°, preferably at most+/−1°).

In case the exact spectral curve of interference pigments is influenced, for example by production variations, and spectral variations thus occur, it is preferable for these spectral variations to be taken into account accordingly in the identification of the locations located on that reflective or optically variable security element. Local fluctuations in the angle of incidence, e.g. as a result of creases in the bank note, can also lead to variations in the diffuse reflectance spectrum obtained in each case; these are preferably taken into account when ascertaining the respective locations. A similar statement applies to magnetically aligned printing pigments should differently oriented interference pigments have been applied to different printing locations, and so the viewing angle, and hence the viewed interference condition, might vary with the respective location (and possible bend/crease angles). Accordingly, variations in the measured spectral shape may also occur here; these are preferably taken into account when ascertaining the relevant locations on the basis of the respectively recorded reflection spectra.

By preference, the irradiation device is configured to (simultaneously or successively) irradiate the respective location on the valuable document with infrared radiation at at least two, in particular at least three, different wavelengths and/or wavelength ranges which in particular have no overlap. In an alternative to that or in addition, the detection device is configured to capture (either with spectral resolution or without spectral resolution) the infrared radiation, diffusely reflected by the respective location, at at least two, in particular at least three, different wavelengths and/or wavelength ranges which in particular have no overlap or only a small overlap.

By preference, in order to capture the diffusely reflected infrared radiation with a spectral resolution, the irradiation device is configured to successively irradiate the respective location on the valuable document with infrared radiation at at least two, in particular at least three, different wavelengths and/or wavelength ranges which in particular have no overlap, and the detection device is configured to successively capture the infrared radiation diffusely reflected from the respective location in each case at the at least two, in particular at least three, different wavelengths and/or wavelength ranges, in order to obtain the respective diffuse reflectance spectrum.

For example, the spectrally resolved diffuse IR reflectance is measured at one or more measurement locations on the valuable document to be tested, by virtue of, in stages, a region of the valuable document being illuminated at the respective measurement location using a first IR light source and the diffusely reflected first intensity being detected, the same region then being illuminated using a second IR light source at a different wavelength and the diffusely reflected second intensity being detected and optionally the same region being illuminated using one or more further IR light sources at different wavelengths and the respective diffusely reflected intensity being detected. In this case, use is preferably made of three, five or more IR light sources at different wavelengths, preferably LEDs, with narrow bandwidth spectra that in particular do not overlap spectrally with one another. By preference, the light from all IR light sources is radiated on the valuable document at approximately the same angle(s) of incidence.

By preference, a transport device is provided, the latter being configured to convey the respective valuable document to be tested relative to the irradiation device and detection device in a transport direction. By preference, the infrared radiation respectively diffusely reflected from a plurality of locations on the valuable document along one or more measurement tracks that run parallel to the transport direction is captured in spectrally resolved fashion here. Then, the testing device uses the diffuse reflectance spectra of the locations of one or more measurement tracks that run parallel to the transport direction to test the valuable document for a reflective security element with an appearance that depends on the viewing angle. By preference, the transport device is configured to convey the valuable document during the measurements at a transport speed of approximately 2 to 11 m/s relative to the irradiation and detection devices. By preference, the irradiation device and the detection device are configured and/or controllable depending on the transport speed such that, especially at high transport speeds as well, the respective measurement locations or regions of the valuable document irradiated by different light sources at different wavelengths overlap by at least 80%, preferably by more than 90%. This ensures that the diffuse reflectance spectrum obtained for the respective measurement location originates from substantially the same region on the valuable document.

In a preferred embodiment, the detection device only comprises one or more discrete detection elements but no image sensor. For example, a respective detection element of the detection device captures the infrared radiation from exactly one of the measurement tracks, and/or the diffusely reflected infrared radiation in each measurement track is captured by exactly one detection element.

By preference, the testing device is configured to test the valuable document on the basis of a total number and/or position of the ascertained location or locations at which such a reflective security element was ascertained as being situated on the valuable document there. For example, the position is tested on the basis of at least one region of interest (ROI) on the valuable document. Testing the valuable document on the basis of the total number/position of ascertained locations is advantageous in that the sensor need not record an image of the valuable document and also need not perform any (usually complicated) comparison between images of the valuable document. The sensor and the testing device thus require less outlay. Moreover, the valuable document test is faster and more easily verifiable-on account of not requiring an image comparison. By preference, the testing device is not designed to compare different images of the valuable document with one another.

By preference, the test on the basis of a total number and/or position of the ascertained location or locations tests whether the total number of ascertained locations (e.g. on the valuable document overall) is greater than or equal to a predetermined first minimum number and/or whether the total number of ascertained locations located within a predetermined region of interest (ROI) on the valuable document is greater than or equal to a predetermined second minimum number and/or whether the total number of ascertained locations located outside of the/a (same or different) predetermined region of interest (ROI) on the valuable document is less than or equal to a predetermined maximum number, in particular equal to zero. Optionally, this can also be carried out for one or more further ROIs on the same valuable document.

For the purpose of testing the state and/or authenticity of the valuable document in particular, the location or locations on the valuable document identified on the basis of the respectively obtained reference spectra are tested in respect of their total number and/or position on the basis of one or more test criteria.

In particular, it is tested whether a respective minimum number of locations at which a reflective security element with an appearance that depends on the viewing angle was ascertained is present in one or more ROIs, which depend on the denomination and/or transport position in particular. The testing device of the sensor can be configured to choose the one or more ROIs here on the basis of the denomination and/or on the basis of the transport position of the respective valuable document.

For example, the valuable document is classified as “authentic” or “fit” if the total number of ascertained locations (at which a reflective security element with an appearance that depends on the viewing angle was ascertained as being situated on the valuable document there) is greater than or equal to a predetermined first minimum number and/or if the total number of ascertained locations located within a predetermined region of interest (ROI) on the valuable document is greater than or equal to a predetermined second minimum number, and otherwise the valuable document is classified as “fake” or “suspected counterfeit” or “unfit”. In an alternative to that or in addition, the valuable document is classified as “authentic” or “fit” (and optionally only in this case) if only the maximum number of ascertained locations/no location with such a reflective security element was ascertained in the/a (same or one or more other) ROI(s).

In an alternative to that or in addition, a test is carried out as to whether a minimum number of locations at which the security element was identified is present overall (this corresponds to a special case of the first case, in which the ROI is given by the whole valuable document). This reliably identifies counterfeits lacking the security element without requiring information regarding e.g. the expected position and/or shape of the security element or the position of the respective valuable document to be tested. In an alternative to that or in addition, especially in addition to the first case, it is possible to test whether only a maximum number of locations (preferably no location at all) at which the OV security element was identified are present outside of the ROIs. All of the aforementioned explanations or cases enable, in each case on their own or in combination, a particularly reliable test, in particular authenticity test and/or state test, of valuable documents.

The position and size of the ROI or the second minimum number can be chosen on the basis of the size and position of the security element to be tested, which are known for the valuable document.

Preferred evaluation methods for ascertaining the locations situated on an OV security element on the valuable document and/or for testing the valuable document on the basis of the locations ascertained in the process, wherein each of the evaluation methods including preferred developments can be used both on its own and in combination with at least one other evaluation method, are described below. Each of these evaluation methods independently allows ascertainment on the basis of the respective diffuse reflectance spectrum as to whether or not a reflective, in particular optically variable, security element with an appearance that depends on the viewing angle is situated on the valuable document at the respective location.

### Evaluation Method 1

By preference, in order to ascertain whether a reflective security element with an appearance that depends on the viewing angle is situated on the valuable document at the respective location, the testing device is configured to ascertain diffuse reflectance values r(λᵢ) at at least two, in particular at least three, different wavelengths λᵢ(i=1, 2, 3, . . . ) and/or wavelength ranges in the diffuse reflectance spectrum obtained for the respective location, to derive at least one first characteristic value that characterizes the respective diffuse reflectance spectrum from said diffuse reflectance values and to compare the first characteristic value with at least one predetermined first comparison characteristic value. The total number and/or position of the different wavelengths λᵢ is/are preferably chosen such that characteristic points in the reference spectrum are thereby captured, e.g. by virtue of a local maximum and/or a local minimum being sampled in a targeted manner. The wavelengths λᵢ to be selected are preferably adapted depending on the application, for example in the case of different hues in different OV security elements. This enables, in a particularly simple manner, a reliable identification of the locations situated on such a reflective or optically variable security element.

By preference, the diffuse reflectance values are determined at at least three different wavelengths in the infrared spectral range. However, for some security elements or spectral curves, it may be sufficient or possible to use one measurement point in the red VIS range and only two wavelength measurement points in the IR spectral range to ascertain the locations situated on the OV security element; this is particularly advantageous for the use in cost-effective sensors in what are known as cash-in systems.

By preference, the first characteristic value is a difference quotient, which is formed from the diffuse reflectance values r(λ₁) to r(λ₄) ascertained in the diffuse reflectance spectrum at three or four different wavelengths λ₁ to λ₄, in particular according to ((r(λ₁)−r(λ₂))/((r(λ₃)−r(λ₄)). In this way, a first characteristic value of the respective diffuse reflectance spectrum that is particularly meaningful in respect of the presence of an OV security element is obtained from the diffuse reflectance values obtained at different wavelengths.

By preference, the at least one predetermined first comparison characteristic value has a lower comparison threshold value and/or an upper comparison threshold value, with which the first characteristic value, in particular the difference quotient, is compared. In the case of predetermined lower and upper comparison threshold values, the at least one first comparison characteristic value thus is provided in the form of an interval, within which the first characteristic value, in particular the difference quotient, must be located in order to affirm the presence of an OV security element.

In an alternative to that or in addition, the testing device is configured to compare at least one of the ascertained diffuse reflectance values, e.g. r(λ₀), and/or at least one second characteristic value, e.g. |r(λ₃)−r(λ₄)|, which is derived from at least some of the ascertained diffuse reflectance values r(λᵢ), with at least one predetermined second comparison characteristic value, e.g. threshold S₀ or S₁.

For example, a diffuse reflectance spectrum obtained from a single measurement location is assessed as OK or the relevant measurement location is identified as a location situated on an OV security element should the diffuse reflectance spectrum have a minimum absorption, by virtue of e.g. r(20)≤So (second comparison characteristic value) applying and the difference quotient (r(2₁)−r(λ₂))/(r(λ₃)−r(λ₄)) being located within a predetermined interval (i.e. between an upper and a lower comparison threshold value). To ensure the numerical stability of the difference quotient, it may preferably be additionally stipulated that the following applies to the absolute value of the denominator: |r(λ₃)−r(λ₄)|≥S₁ (second comparison characteristic value).

For example, this simple machine-based method allows color-shift OV security elements (known as color-shift colors), the color of which depends on the viewing angle, to be reliably distinguished from conventional inks and IR absorber colors.

In simplified embodiments, λ₁ and λ₃ can be identical, i.e. diffuse reflectance values at only three different wavelengths are used to calculate the difference quotient or ascertain the locations situated on the OV security element. Further, λ₀ can coincide with one of the wavelengths λ₁ to λ₄. In an alternative to that or in addition, r(λ₀) can represent a mean value of a plurality of diffuse reflectance values from r(λ₁) to r(λ₄). In a further embodiment, the diffuse reflectance spectrum can be tested more accurately by virtue of not only ascertaining or testing one difference quotient but by ascertaining and testing two or more difference quotients using further wavelengths.

Overall, this evaluation method is suitable for small, relatively cost-effective sensors in particular, since only three different wavelengths (only two different wavelengths of which optionally are in the IR) are required for sampling in the simple case, and the evaluation requires relatively little numerical outlay.

### Evaluation Method 2

By preference, in order to ascertain whether a reflective security element with an appearance that depends on the viewing angle is situated on the valuable document at the respective location, the testing device is configured to ascertain a distance between the diffuse reflectance spectrum, in particular the normalized diffuse reflectance spectrum, obtained for the respective location and at least one predetermined reference spectrum, in particular at least one predetermined normalized reference spectrum, and to test whether the ascertained distance is less than a predetermined comparison distance.

In principle, the preferably performed normalizations of the respective diffuse reflectance spectrum and reference spectrum can use any type of normalization that ensures that fluctuations caused by the respective measurement or comparison measurement (for the reference spectrum), for instance in the intensity of the infrared radiation incident on the respective location and/or in the sensitivity of the detector device during the capture of the infrared radiation diffusely reflected by the location, are substantially eliminated. By preference, the respective diffuse reflectance spectrum to be tested and the associated reference spectrum are normalized e.g. by a linear transformation which maps the minimum to 0 and the maximum to 1. For example, such a normalization is implemented according to the following formula: rᵢ^{norm}=((rᵢ−min)/(max−min))_{i=1 . . . n}, where the diffuse reflectance spectrum to be tested, which is sampled at n wavelengths, is given by the diffuse reflectance values r₁, . . . , rₙ, and “min” is the minimum of all rᵢ, and “max” is the maximum of all rᵢ. In an alternative, such a normalization can for example also be implemented by a linear transformation in which the mean value is 0 and the standard deviation is 1, for example according to the following formula: rᵢ^{norm}=((rᵢ−μ)/σ_{i=1 . . . n}, where μ is the mean value of rᵢ, and σ is the standard deviation of all rᵢ.

By preference, the distance between the two normalized spectra (measured diffuse reflectance spectrum versus reference spectrum) is ascertained e.g. using a p-norm of their difference, and then a test is carried out as to whether the latter is less than a predetermined threshold. Let the normalized diffuse reflectance spectrum be given by the diffuse reflectance values r₁^{norm}, . . . , rₙ^{norm} and the normalized reference spectrum be given by the values R₁, . . . . Rₙ, then the pointwise difference xᵢ=rᵢnorm−Rᵢ is ascertained first. The p-norm of the difference is then defined by the formula:

$${( {\sum }_{i = 1}^{n} {\vert {x}_{i} \vert}^{p} )}^{1 / p} .$$

This corresponds to the Euclidean distance for p=2. The arising spectral variations are caught by a suitable choice of the threshold, and the OV security elements on the banknotes of all production batches are recognized as fit or authentic.

This evaluation method is particularly suitable for cases in which the spectrum was sampled at a plurality of wavelengths, in particular more than three or four wavelengths, such that an entire spectral curve is available. These cases offer a complete and very accurate test of the entire spectral curve despite a very simple adaptation.

### Evaluation Method 3

By preference, in order to ascertain whether a reflective security element with an appearance that depends on the viewing angle is situated on the valuable document at the respective location, the testing device is configured to ascertain a difference between the diffuse reflectance spectrum obtained for the respective location and a comparison spectrum that has been fitted to the diffuse reflectance spectrum and to test whether the ascertained difference is less than a predetermined comparison difference, the comparison spectrum preferably given by a linear combination of at least two predetermined reference spectra. By preference, the predetermined reference spectra are representative reference diffuse reflectance spectra which for example may occur in extreme cases on account of production variations and/or on account of different pigment alignments within a banknote. By preference, the diffuse reflectance spectrum (to be tested) obtained at a location in each case is fitted using the reference diffuse reflectance spectra A and B, e.g. by the linear combination c₁ A+c₂ B, the so-called fit spectrum, with the fit parameters c₁ and c₂. In a preferred embodiment, the ranges of the coefficients c₁ and c₂ that are admissible for the fit are subject to predefined restrictions, e.g. c₁>0 and c₂>0. Then, a test is carried out as to how well this fit fits, e.g. by determining a p-norm of the difference between measured diffuse reflectance spectrum and fit spectrum, and by comparing the p-norm with a correspondingly predetermined comparison difference. A more accurate fit is obtained by the linear combination c₀+c₁ A+c₂ B, which has an additional fit parameter c₀, the offset. By preference, this case should exclude the possibility of each constant spectrum being able to be fitted exactly with c₁=c₂=0, by virtue of only taking into account pixels or measurement locations at which the fit, e.g. |c₁|+|c₂|, is above a predetermined threshold or whose diffuse reflectance spectrum is sufficiently nonconstant such that e.g. the standard deviation or the difference between maximum and minimum is located above a predetermined threshold.

This method can be further improved if a preselection of the diffuse reflectance spectra to be tested is additionally carried out. By preference, provision can be made here for the test of the valuable document to take into account only those pixels or measurement locations whose diffuse reflectance spectrum in the IR range differs sufficiently from a constant curve, e.g. at which the difference between maximum and minimum exceeds a predetermined threshold. It is assumed that an IR absorption feature is present at these locations.

Accordingly, the testing device is preferably configured to consider only those locations in the valuable document test for which a respective diffuse reflectance spectrum was obtained that satisfies at least one of the following conditions: i) the diffuse reflectance spectrum curve is not constant and/or has a predetermined minimum difference from a constant curve, and/or ii) the difference between a maximum and a minimum of the diffuse reflectance spectrum is greater than a predetermined minimum difference.

By preference, such a preselection can optionally also be used in the other evaluation methods 1, 2, 4 or 5.

This evaluation method is also particularly suitable for applications in which the diffuse reflectance spectrum was sampled at a plurality of wavelengths such that an entire spectral curve is available in one or more measurement tracks. These cases lend themselves to a particularly robust and stable identification of the OV security elements. Moreover, the evaluation method is particularly suitable for OV security elements with printed interference pigments that have different alignments locally.

### Evaluation Method 4

By preference, in order to ascertain whether a reflective security element with an appearance that depends on the viewing angle is situated on the valuable document at the respective location, the testing device is configured to form a derivative curve by differentiating the diffuse reflectance spectrum, in particular the normalized diffuse reflectance spectrum, obtained for the respective location with respect to wavelength and to test whether the derivative curve is located within a predetermined tolerance range and/or has a difference from a predetermined target derivative curve that is less than a predetermined maximum distance. By preference, the respective diffuse reflectance spectrum to be tested is initially normalized, for example by a linear transformation which maps the minimum to 0 and the maximum to 1 (see above for the formula) or by a linear transformation such that (μ, σ)=(0, 1) (see above for the formula). By preference, the derivative curve (1st derivative with respect to the wavelength) is subsequently formed. For example, for a diffuse reflectance spectrum available in the form of n intensity values (r(2ᵢ))_{i=1, . . . ,n}, the derivative can be calculated as (r′(λᵢ))_{i=2 . . . ,n}=((r(i)−r(λᵢ₋₁))/(λᵢ−λᵢ₋₁))_{i=2 . . . ,n}. A test as to whether this derivative curve is located within the predetermined tolerance range is subsequently carried out. The predetermined tolerance range can e.g. be ascertained in advance by virtue of the respective derivative curve being calculated for a multiplicity of normalized diffuse reflectance spectra obtained at (comparison) valuable documents and the mean value and the standard deviation being ascertained for each wavelength.

Should the test include not only whether the respectively obtained diffuse reflectance spectrum fits but also how well it fits, it is possible in an alternative to that or in addition to calculate a difference curve from the target derivative curve, e.g. the “channel-by-channel” (i.e. wavelength-by-wavelength) difference curve, weighted by the reciprocal width of the tolerance range, from the target derivative curve, and to reduce this to one value, e.g. using a p-norm. This value can then be compared with an upper threshold, with the presence of an OV security element being affirmed if the upper threshold is not exceeded.

This method is particularly suitable for cases in which the respective diffuse reflectance spectrum was sampled at a plurality of wavelengths (particularly preferably: at a multiplicity of wavelengths) such that an entire spectral curve is available. In these cases, this offers a particularly precise separation of spectra from different OVI elements despite little adaptation outlay.

### Evaluation Method 5

By preference, in order to ascertain whether a reflective security element with an appearance that depends on the viewing angle is situated on the valuable document at the respective location, the testing device is configured to ascertain the wavelengths of two or more local extrema, in particular of at least one local maximum and at least one local minimum, in the diffuse reflectance spectrum obtained for the respective location and to test whether the ascertained wavelengths are located within wavelength intervals that are predetermined for the respective extrema and/or whether there is in each case only one local extremum within a wavelength interval that is predetermined for the respective extremum. By preference, the testing device in this case is configured to form a quotient of in each case two ascertained wavelengths and to test whether the quotient is located within a predetermined tolerance range.

Thus, the wavelengths of the (possibly interpolated) local extrema of the diffuse reflectance spectrum are initially determined. Then, wavelength intervals defined in advance for the minima and maxima are used to test whether a local minimum or maximum, in particular exactly one local minimum or maximum, is present in each of the wavelength intervals. In an alternative to that or in addition, a selection of pairs of predetermined wavelength intervals is defined, and a test is carried out as to whether the quotients of the wavelengths of the associated extrema are located in predetermined tolerance ranges. By preference, wavelength intervals are specified for one to three minima and one to three maxima. By preference, one maximum and two minima are located in the IR range. For example, wavelength intervals are defined for one maximum and one minimum, one maximum and two minima, two maxima and one minimum, two maxima and two minima, two maxima and three minima, three maxima and two minima or three maxima and three minima.

This method is particularly suitable for cases in which the diffuse reflectance spectrum was sampled at a plurality of individual wavelengths. It is not absolutely necessary for an entire spectral curve to be available here. In this context, it offers particularly little adaptation outlay since it is possible by way of a single adaptation to simultaneously identify a lot of different OV color impressions based on interference and reliably distinguish these from absorption pigments.

Further advantages, features and application possibilities of the present invention will become apparent from the following description in association with the figures, in which:

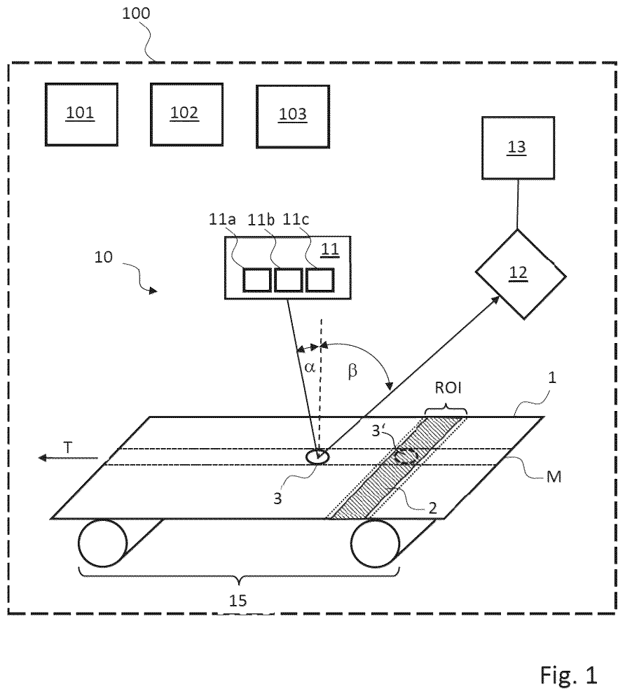

FIG. 1 shows an example of a sensor for testing valuable documents;

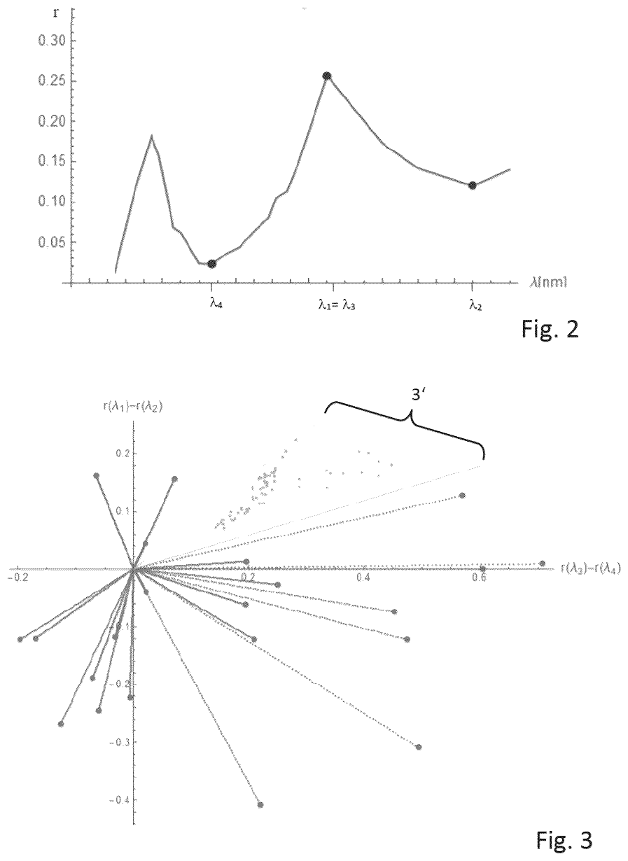

FIG. 2 shows a first example of a diffuse reflectance spectrum;

FIG. 3 shows a first example of a diagram depicting the numerator and denominator of difference quotients;

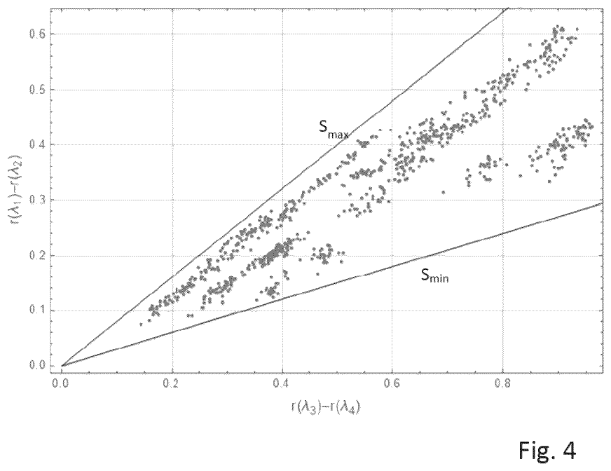

FIG. 4 shows a second example of a diagram depicting the numerator and denominator of difference quotients;

FIG. 5 shows examples of diffuse reflectance spectra before (left) and after(center, right) a normalization;

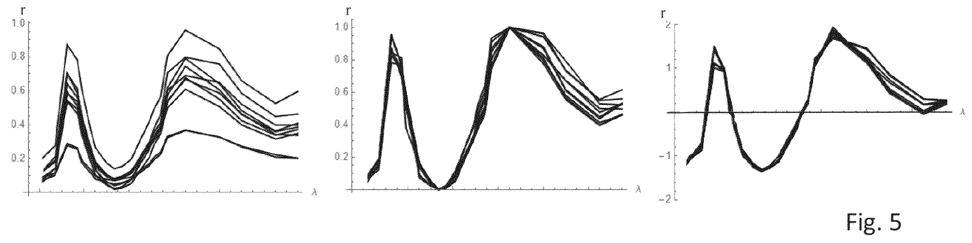

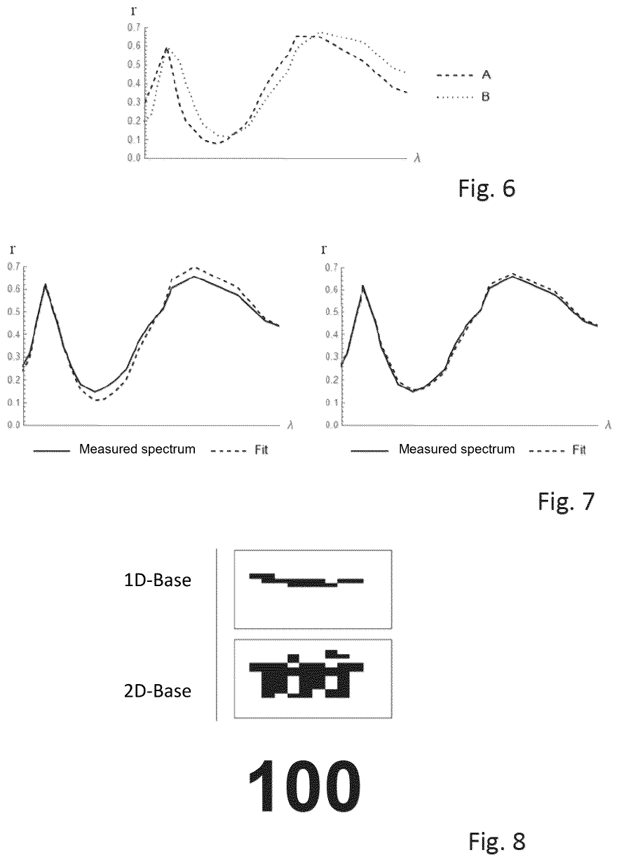

FIG. 6 shows examples of reference spectra;

FIG. 7 shows examples for illustrating fitting of a diffuse reflectance spectrum by means of a first linear combination of the reference spectra (left) and a second linear combination of the reference spectra (right);

FIG. 8 shows examples of locations ascertained with one-dimensional and two-dimensional fitting;

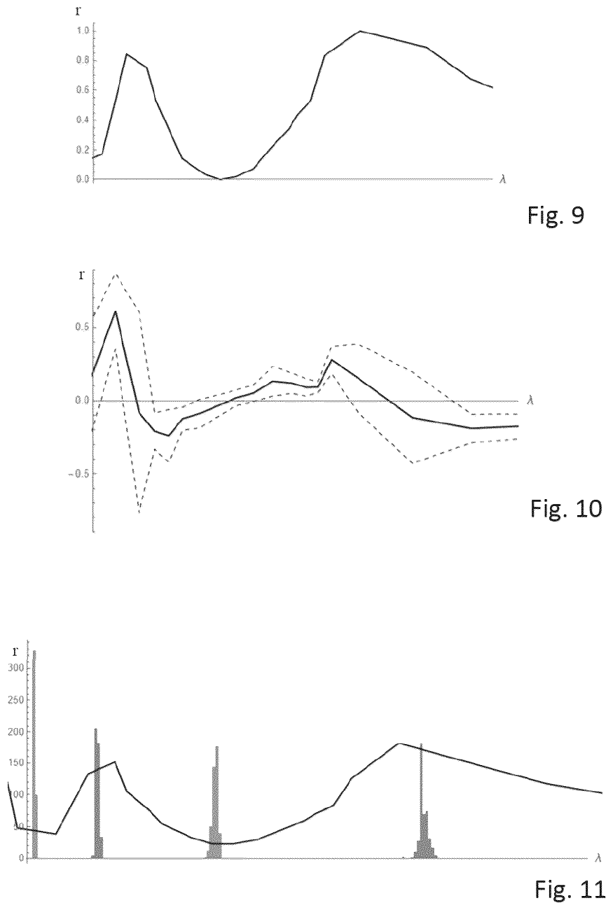

FIG. 9 shows an example of a normalized diffuse reflectance spectrum;

FIG. 10 shows an example of a derivative curve calculated from the normalized diffuse reflectance spectrum shown in FIG. 9 and of a predetermined tolerance range; and

FIG. 11 shows an example of a diffuse reflectance spectrum, in which distributions of the respective spectral position of local minima and maxima of a plurality of measured diffuse reflectance spectra are plotted.

FIG. 1 shows a schematic illustration of an example of a sensor 10 for testing valuable documents 1, in particular banknotes, which comprise at least one such reflective, optically variable (OV) security element 2.

In the present example, the security element 2 is in the form of what is known as a LEAD strip, which extends over the entire width of the valuable document 1. Such a LEAD strip is applied to e.g. a paper primer and provided with an integrating overprint, typically using intaglio embossing.

In principle, however, the security element 2 can have any other desired form and/or be based on other functional principles for creating an appearance that depends on the viewing angle, especially in the visible spectral range, for example in the form of film elements, patches, wide security threads or printed-on, magnetically aligned interference pigments. Thus, in addition to micromirrors, film-based OV security elements also use stacks of thin layer-thickness-controlled layers in order to bring about angle-dependent interference colors or color changes.

The sensor 10 comprises an irradiation device 11 that is configured to irradiate a plurality of different locations 3, 3′ with infrared radiation. By preference, this illumination of the different locations is implemented sequentially in time. In the context of the present disclosure, the different locations 3, 3′ are also referred to as “measurement locations”, “measurement pixels” or “pixels”. The infrared radiation diffusely reflected by the different locations 3, 3′ in each case is captured by a detection device 12, with a diffuse reflectance spectrum being obtained for each of the locations 3, 3′.

The irradiation device 11 and/or the detection device 12 can be designed in various ways to obtain a respective diffuse reflectance spectrum from the locations 3, 3′. Thus, a general case can provide for e.g. the irradiation device 11 to irradiate the valuable document 1 with broad bandwidth infrared radiation and for the detection device 12 to capture the diffusely reflected infrared radiation with spectral resolution at a multiplicity of different wavelengths.

However, in a particularly preferred variant which is simple to realize, provision can also be made for the irradiation device 11 to comprise two or more different radiation sources 11a to 11c, which emit infrared radiation at different wavelengths or in different wavelength ranges used to successively irradiate the respective location 3, 3′. In this case, the detection device 12 is preferably configured to capture the infrared radiation successively diffusely reflected by the respective location 3, 3′ at different wavelengths, whereby a diffuse reflectance spectrum with diffuse reflectance values at different wavelengths, which total three in the present example, is obtained for each location 3, 3′.

Only two locations 3, 3′ have been plotted in the present case for reasons of clarity. However, it is preferable for a respective diffuse reflectance spectrum to be recorded at a plurality of locations 3, 3′ on the valuable document 1. Further, for reasons of clarity, the locations 3, 3′ or the corresponding regions that are irradiated by infrared radiation or from which the diffusely reflected infrared radiation is captured are depicted relatively large. In principle, the regions at the locations 3, 3′ can be smaller, optionally also significantly smaller, or else larger, depending on the minimal spatial resolution required for the geometric extent of the security elements to be tested.

In principle, the locations 3, 3′ or the respective regions can have any desired shape. In the case of a detection device 12 with one or more rectangular, more particularly square, detector elements, the locations 3, 3′ preferably have a substantially rectangular or square shape. In the case of a detection device 12 with one or more round detector elements, the locations 3, 3′ preferably have a substantially oval or round shape.

By preference, a transport device 15 indicated only schematically in the example shown is provided, the said transport device being configured to convey the valuable document 1 to be tested relative to the irradiation device 11 and detection device 12 in a transport direction T.

By preference, the infrared radiation respectively diffusely reflected from a plurality of locations 3, 3′ along one or more measurement tracks M that run parallel to the transport direction T is successively captured. For reasons of clarity, the locations 3, 3′ are only shown along a single measurement track M in the present example.

In principle, however, the irradiation device 11 and/or the detection device 12 might also be designed such that diffuse reflectance spectra from two, preferably six or a plurality of measurement tracks M that run parallel to one another can be captured at in each case two, preferably six, or a plurality of locations.

In an alternative to that or in addition, it is preferable for the irradiation device 11 to be configured to irradiate a linear region of the valuable document 1 that runs substantially perpendicular to the transport direction T with infrared radiation and for the detection device 12 to comprise what is known as a sensor line with a plurality of detector elements that are arranged perpendicular to the transport direction T and that can be used to capture, with spatial resolution, the infrared radiation diffusely reflected by the irradiated linear region of the valuable document 1. By preference, this embodiment makes use of only a few different infrared wavelengths, in particular two different infrared wavelengths or three different infrared wavelengths, in alternation. A spectrally resolved diffuse reflectance image of the entire valuable document 1, the picture elements (pixels) of which are formed by the individual locations 3, 3′, is obtained by a successive capture of infrared radiation diffusely reflected in each case while the valuable document 1 is conveyed in the transport direction T.

The infrared beam created by the irradiation device 11 is incident on the respective location 3 at a mean angle of incidence a (with respect to the valuable document 1 normal), and the infrared radiation diffusely reflected by the location 3 is captured by the detection device 12 at a detection angle β that preferably differs from the mean angle of incidence a. It is furthermore preferable that all examined locations 3, 3′ on the valuable document 1 are measured with only a single angle condition for all wavelengths, i.e. a single angle of incidence a and a single detection angle β.

The sensor 10 furthermore comprises a testing device 13 which is configured to use the diffuse reflectance spectra obtained for the different locations 3, 3′ in each case to ascertain whether the relevant location 3, 3′ is located at or on the reflective optically variable (OV) security element 2. For example, this is implemented by processing and/or analyzing the respectively obtained diffuse reflectance spectrum and/or by way of a comparison with one or more predetermined spectra. This will still be explained in detail below on the basis of preferred evaluation methods.

Then, the valuable document 1 is tested on the basis of the locations 3, 3′ ascertained or classified in this way (e.g. “not on the OV security element” or “on the OV security element”), wherein use is made in particular of the total number and/or position of the ascertained locations 3′ or locations 3′ classified as “on the OV security element”.

By preference, a test is carried out here as to whether the total number of ascertained locations 3′, or locations 3′ classified as “on the OV security element”, on the valuable document is greater than or equal to a predetermined first minimum number, which may depend e.g. on the size of the security element 2. In this way, a single security element 2 on the valuable document 1 can be reliably verified.

In an alternative to that or in addition, there can be e.g. a test as to whether the total number of locations 3′ ascertained as located within at least one respective predetermined region of interest ROI or classified as “on the OV security element” is greater than or equal to a respective predetermined second minimum number. In this way, it is possible to reliably verify not only the presence of a security element 2 on the valuable document 1 but also its correct position (in the ROI) and/or minimum size (second minimum number). Further, it is also possible in the process to test this for two or more different reflective optically variable security elements on the valuable document 1.

Optionally, there can also be a test as to whether the total number of ascertained locations 3′, or locations 3′ classified as “on the OV security element”, which are located outside of the predetermined region of interest ROI is less than or equal to a predetermined maximum number, in particular equal to 0. The ensures that hardly any, or no, locations classified as “on the OV security element” are present outside of the region of interest ROI.

Should one or more of these test criteria be affirmed, the valuable document 1 is classified as e.g. “authentic” and/or “fit”. Otherwise, the valuable document 1 is classified as “counterfeit” and/or “unfit”.

By preference, the sensor 10 is used in a valuable document processing system 100, which is only indicated very schematically in the present example and which comprises one or more processing apparatuses 101 to 103 that are configured to process valuable documents 1, in particular to separate out, transport, test, sort, stack and/or destroy these.

In the following, preferred evaluation methods for ascertaining or classifying the locations 3′ situated on the security element 2 or for testing the valuable document 1 on the basis of the ascertained locations 3′ are explained in detail and in exemplary fashion with reference to the figures.

### Evaluation Method 1

In this preferred method, the diffuse reflectance r(λ) at the respective location 3, 3′ is initially measured for(at least) three different wavelengths Aj. By preference, these are chosen such that characteristic points in the spectrum are captured therewith, said points being known to be characteristic for the diffuse reflectance spectrum of the OV security element to be tested, e.g. points at which said spectrum has a maximum or a minimum. By preference, the wavelengths to be assessed are adapted for different OV hues.

A diffuse reflectance spectrum recorded in this way at a single measurement location 3, 3′ is preferably classified as “on the OV security element” if it has a minimum absorption at one or more wavelengths (e.g. r(2)≤threshold S₀) and the difference quotient (r(λ₁)−r(λ₂))/(r(λ₃)r (λ₄)) is located within a predetermined interval and (on account of the numerical stability of the quotient) the following applies to the absolute value of the denominator: |r(λ₃)−r(λ₄)|≥threshold S₁.

For example, this simple method allows reflective optically variable security elements, the color of which depends on the viewing angle and which are also referred to as “color-shift OV security elements” within the scope of the present disclosure, to be distinguished from normal banknote and IR absorber colors. In further simplified preferred embodiments, λ₁ and λ₃ can coincide to be identical. λ₀ can coincide with one of the wavelengths λ₁ to λ₄, or r(λ₀) can represent a mean value of a plurality of diffuse reflectance values, chosen from r(M) to r(λ₄). In a furthe preferred embodiment, the diffuse reflectance spectrum can be tested more accurately by virtue of not only ascertaining and testing one difference quotient but by ascertaining and testing two or more difference quotients using further wavelengths.

For some spectral curves, it is even possible to perform this test using one measurement point in the red visible (VIS) spectral range and only two wavelength measurement points in the IR spectral range, which is relevant to cost-effective so-called cash-in sensors, in particular.

FIGS. 2 to 4 illustrate how a reflective optically variable security element whose color depends on the viewing angle is separated from conventional colors by testing (r(1100 nm)r(1520 nm))/(r(1100 nm)−r(770 nm))∈[0.3, 0.8].

FIG. 2 shows a first example of a diffuse reflectance spectrum of an OV film strip. A characteristic IR signature of the film strip can be uniquely identified or determined by evaluating characteristic diffuse reflectance values (at the marked wavelengths λ₁=λ₃, λ₂, λ₄) and calculating the difference quotient therefrom. Wavelengths at which the diffuse reflectance curve has a local maximum or minimum are preferably used for selecting the spectral values used for the evaluation.

FIG. 3 shows a first example of a diagram with an illustration of the numerator and denominator of difference quotients of different measurement pixels 3′ (small points) of an OV film strip in comparison with different IR absorber pigments (larger individual points). Here, the diffuse reflectance intensities r(λ₁) to (24) at the same wavelengths λ₁ to λ₄ were used in each case. The IR signature of the OV film strip-characterized by the difference quotient which corresponds to the origin angle in the presently chosen illustration-is clearly distinguishable from all IR absorber colors.

FIG. 4 shows a second example of a diagram with an illustration of the numerator and denominator of difference quotients of different measurement pixels of different production batches of an OV film strip. Here, the diffuse reflectance intensities r(λ₁) to (24) at the same wavelengths λ₁ to λ₄ were used in each case. By preference, the scattering of the calculated values due to production variations is considered by the choice of a suitable test interval which is preferably predetermined by a lower comparison threshold value Sₘᵢₙ and an upper comparison threshold value Smax. Suitable choice of this interval allows the spectral variations arising on account of production variations to be easily captured, and so it is possible to reliably recognize not only a single banknote but the OV security elements of banknotes from all production batches. The influence of production variations on the test of the OV security elements is reliably eliminated or at least kept low in this manner.

The respective difference quotient can be gathered from FIGS. 3 and 4 by virtue of theoretically forming the quotient y/x for a point (x, y). Thus, the respective difference quotient corresponds to the gradient of the line through the origin and the relevant point. The two plotted lines through the origin with gradients of 0.3 and 0.8 represent the limits [0.3, 0.8] of the allowed range for the difference quotients.

### Evaluation Method 2

The assumption made in this preferred method is that a diffuse reflectance spectrum to be tested, in each case sampled at n wavelengths, is given by the diffuse reflectance values (r₁, . . . , In). In a first step, the diffuse reflectance spectrum of the OV film strip to be tested, from the above-described example, and a reference spectrum are normalized, e.g. by a linear transformation which maps the minimum to 0 and the maximum to 1, for example according to the following formula: rᵢ^{norm}=((rᵢ−min)/(max−min))_{i=1 . . . n}, where “min” is the minimum of all rᵢ, and “max” is the maximum of all rᵢ, or by a linear transformation such that the mean value is 0 and the standard deviation is 1, for example according to the formula: rᵢ^{norm}=((rᵢ−μ)/σ)_{i=1 . . . n}, where μ is the mean value of all rᵢ, and σ is the standard deviation of all rᵢ.

FIG. 5 shows examples of diffuse reflectance spectra of different measurement locations on the OV film element before (left) and after(center, right) a normalization. As evident therefrom, the original diffuse reflectance spectra (left) exhibit a significant variation that is markedly reduced by a linear normalization (center, right), and so a quantitative comparison with a normalized reference spectrum is rendered possible.

Subsequently, a distance between the two normalized spectra (measured diffuse reflectance spectrum versus reference spectrum) is determined, e.g. using a p-norm of their difference, and a test is carried out as to whether the latter is less than a predetermined threshold, which is also referred to as “comparison distance” in the context of the present disclosure. Suitable choice of this threshold captures the spectral variations arising, and so OV security elements of valuable documents or banknotes of all production batches can be reliably identified.

### Evaluation Method 3

The assumption made in this preferred method is that the diffuse reflectance spectra of OV security elements measured or to be measured e.g. for production variations occurring in the extreme case and/or for spectral variations within a banknote that arise due to different pigment alignments can be approximated by means of representative reference diffusion reflectance spectra A and B.

By preference, the diffuse reflectance spectrum to be tested that is obtained in each case is approximated (by what is known as fitting) by the reference diffuse reflectance spectra A and B by way of a first linear combination c₁*A+c₂*B, the fit spectrum with the fit parameters c₁ and c₂, and how well the fit fits is tested, e.g. using a p-norm of the difference between measured diffuse reflectance spectrum and fit spectrum, which is also referred to as (fitted) “comparison spectrum” in the context of the present disclosure.

Optionally, the fit obtained by means of a second linear combination c₀+c₁*A+c₂*B, which has an additional fit parameter c₀, the offset, is even more accurate. By preference, consideration here should be given to the fact that every constant spectrum could be fitted exactly by way of c₁=c₂=0. To exclude this case, consideration is preferably only given to pixels or locations at which the fit, e.g. |c₁|+|c₂|, is above a predetermined threshold or whose respective diffuse reflectance spectrum is sufficiently non-constant such that e.g. the standard deviation or the difference between maximum and minimum is located above a predetermined threshold.

FIG. 6 shows examples of two reference diffuse reflectance spectra, the linear combination of which is fitted to a measured diffuse reflectance spectrum. FIG. 7 shows examples for illustrating a fit (dashed line) of a measured diffuse reflectance spectrum (solid line) by the above-described first linear combination of the reference diffuse reflectance spectra (left) and the above-described second linear combination of the reference diffuse reflectance spectra with an offset (right).

The method can be improved further if there is an additional preselection of the diffuse reflectance spectra to be tested, by virtue of using only those pixels or locations in the evaluation whose diffuse reflectance curve in the IR range is sufficiently different from a constant curve, e.g. for which the difference between maximum and minimum exceeds a predetermined threshold. It is assumed that an IR absorption feature is present at these points. This preselection can optionally also be used in the other evaluation methods.

In the following example, the above-described 2-dimensional fit of a respective diffuse reflectance spectrum to be tested by the two reference spectra A and B (with fit parameters c₁ and c₂ and optionally c₀) is demonstrated for a value number “100” printed with magnetically aligned interference pigments and is compared with the case of a fit by a single reference diffuse reflectance spectrum (1-dimensional fit).

FIG. 8 shows a comparison of the locations or measurement pixels of a lettering “100”, printed with aligned interference pigments, that are correctly identified with a 1-dimensional fit (top) and with a 2-dimensional fit (bottom). In the pixel images reproduced here, the measurement locations at which the distance (e.g. p-norm with p=2, i.e. the Euclidean distance) between the fitted spectrum (fit spectrum or comparison spectrum) and the measured diffuse reflectance spectrum is less than a test threshold, which is also referred to as “comparison difference” in the context of the present disclosure, are plotted black.

To assess authenticity, a test is carried out as to whether a minimum number of pixels or locations satisfies this criterion. In addition to that or in an alternative, a comparison with the expected shape of the “100” is also possible in the case of a sufficient spatial resolution of the measurement.

In the case of a 1-dimensional fit, only relatively few valid pixels are obtained in comparison with the 2-dimensional fit. Since the alignment of the interference pigments varies systematically over the height in this printed image, the pixels fitting the reference are concentrated in a narrow height range in the 1-dimensional case. Preferably, this is taken into account in the case of sensors with only a few measurement tracks (or optionally only one measurement track) by virtue of the position thereof being matched as accurately as possible to this narrow range in the case of an evaluation with a 1-dimensional fit. To keep possible influences as low as possible, for example on account of so-called high/low running variations during the transport of the respective valuable document to be tested, an evaluation with a 2-dimensional fit is preferred since the latter is substantially more tolerant in relation to the position of the respective measurement track or the track height than the evaluation with a 1-dimensional fit.

### Evaluation Method 4

In this preferred method, the respective diffuse reflectance spectrum to be tested is initially normalized, e.g. by a linear transformation which maps the minimum to 0 and the maximum to 1, for example according to the following formula: rᵢ^{norm}=((rᵢ−min)/(max−min))_{i=1 . . . n} (see above), or by a linear transformation such that (μ, σ)=(0,1) holds true, for example according to the formula rᵢ^{norm}=((rᵢ−μ/σ)_{i=1 . . . n} (see above).

Then, the derivative curve (1st derivative with respect to wavelength) of the normalized diffuse reflectance spectrum is formed, and a test is carried out as to whether the derivative curve is located within a predetermined tolerance range. By preference, the tolerance range is ascertained or predetermined by virtue of the derivative curves being calculated for a multiplicity of authentic normalized diffuse reflectance spectra, i.e. spectra measured on authentic banknotes or reference patterns, and the mean value and the standard deviation being ascertained for each wavelength. Then, the tolerance range corresponds to the area around the spectral curve of the ascertained mean values, which is bounded by the spectral curve of the ascertained standard deviations.

FIG. 9 shows an example of a normalized diffuse reflectance spectrum. FIG. 10 shows an example of a derivative curve (solid line) calculated therefrom and of a predetermined tolerance range (dashed lines).

Should the test include not only whether the respective diffuse reflectance spectrum fits but also how well it fits, it is possible in an alternative to also calculate a difference curve, weighted channel-by-channel (i.e. with respect to the individual wavelengths) by the reciprocal width of the tolerance range, between the respective derivative curve and a predetermined target derivative curve, and to then reduce this to one value, e.g. using a p-norm. This value can then be compared with an upper threshold, which is also referred to as “maximum difference” in the context of the present disclosure.

### Evaluation Method 5

In this preferred method, the wavelengths of the (possibly interpolated) local extrema of the diffuse reflectance spectrum obtained in each case are determined. Further, intervals are determined or predetermined in advance for the minima and maxima; these are also referred to as “wavelength intervals” in the context of the present disclosure. Then, a test is carried out whether there is exactly one local minimum or maximum in each of these intervals. Optionally, a selection of pairs of these intervals can additionally be defined or predetermined, and a test can be carried out as to whether the quotients of the wavelengths of the associated extrema are located in predetermined tolerance ranges. By preference, such wavelength intervals are defined for one to three minima and one to three maxima. By preference, one maximum and two minima are located in the IR range. For example, wavelength intervals are defined for one maximum and one minimum, one maximum and two minima, two maxima and one minimum, two maxima and two minima, two maxima and three minima, three maxima and two minima or three maxima and three minima.

FIG. 11 shows an example of a diffuse reflectance spectrum, in which frequency distributions of the respective spectral position of local minima “min” and maxima “max” of a plurality of measured diffuse reflectance spectra are plotted.

In general, color-shift OV security elements are provided in different colors for different currencies and denominations, and possibly even at different locations within one banknote. To keep the adaptation outlay as low as possible, it is preferably possible to undertake a simplified albeit slightly less accurate test for such color-shift OV security elements. To this end, a special case of the above-described evaluation with a lower adaptation outlay can be used as follows: Initially, two generous intervals are selected for minima, e.g. [600 nm, 1000 nm] and [1000 nm, 1700 nm], and then the quotient of the wavelengths of the associated minima is tested as to whether it is located e.g. in the interval of [1.6, 1.75] or, more accurately, whether it is located in a type-dependent narrower interval. This does not test whether a color-shift OV security element with a specific hue is present, but only whether such an OV security element of any hue is present. Nevertheless, this enables reliable identification of a lack of a color-shift OV security element and/or an identification of normal colors and IR absorber colors, and the corresponding banknote can be rejected or classified as counterfeit.

1.-15. (canceled)

16. A sensor for testing valuable documents comprising at least one reflective security element that in the visible spectral range has an appearance that depends on a viewing angle, having:
an irradiation device configured to irradiate one or more different locations on a valuable document with infrared radiation,
a detection device configured to capture the infrared radiation diffusely reflected from the respective location on the valuable document, the sensor being configured to capture the diffusely reflected infrared resolution in spectrally resolved fashion in order to obtain a diffuse reflectance spectrum at the respective measurement location, and
a testing device for testing the valuable document in view of a reflective security element that has an appearance that depends on the viewing angle, the testing device being configured to use the diffuse reflectance spectrum obtained for the respective location to ascertain whether a reflective security element with an appearance that depends on the viewing angle is situated on the valuable document at the respective location in order to ascertain one or more locations at which such a reflective security element is situated on the valuable document and in order to test the valuable document on the basis of the ascertained location or locations.

17. The sensor according to claim 16, wherein the detection device is configured and/or arranged to capture the infrared radiation diffusely reflected from the respective location at a detection angle (B), and/or the irradiation device is configured and/or arranged to direct the infrared radiation at the valuable document in such a way that said infrared radiation is incident on the valuable document at an angle of incidence (a), the detection angle (B) and the angle of incidence (a) having different magnitudes.

18. The sensor according to claim 16, wherein the testing device is configured to use only infrared radiation directed at the valuable document at exactly or approximately a single angle of incidence and captured from exactly or approximately a single detection angle for the ascertainment as to whether a reflective security element with an appearance that depends on the viewing angle is situated at the respective location on the valuable document.

19. The sensor according to claim 16, wherein in order to capture the diffusely reflected infrared radiation with a spectral resolution, the irradiation device is configured to successively irradiate the respective location on the valuable document with infrared radiation at at least two different wavelengths (λi) and/or wave-length ranges which in have no overlap, and the detection device is configured to successively capture the infrared radiation diffusely reflected from the respective location in each case at the at least two different wavelengths (λi) and/or wavelength ranges, in order to obtain the respective diffuse reflectance spectrum.

20. The sensor according to claim 16, wherein the testing device is configured to test the valuable document on the basis of a total number and/or position of the ascertained location or locations at which a reflective security element with an appearance that depends on the viewing angle was ascertained as being situated on the valuable document there.

21. The sensor according to claim 20, wherein the testing device is configured to test whether the total number of ascertained locations is greater than or equal to a predetermined first minimum number and/or whether the total number of ascertained locations located within a predetermined region of interest (ROI) on the valuable document is greater than or equal to a predetermined second minimum number and/or whether the total number of ascertained locations located outside of a predetermined region of interest (ROI) on the valuable document is less than or equal to a predetermined maximum number.

22. The sensor according to claim 16, wherein in order to ascertain whether a reflective security element with an appearance that depends on the viewing angle is situated on the valuable document at the respective location, the testing device is configured to ascertain diffuse reflectance values (ri, r(λi)) at at least two different wavelengths (λi) in the diffuse reflectance spectrum obtained for the respective location, to derive at least one first characteristic value that characterizes the respective diffuse reflectance spectrum from said diffuse reflectance values and to compare the first characteristic value with at least one predetermined first comparison characteristic value.

23. The sensor according to claim 22, wherein the first characteristic value is a difference quotient, which is formed from the diffuse reflectance values (r(λ1) to r(λ→)) ascertained in the diffuse reflectance spectrum at three of four different wavelengths (21 to λ4), as follows: ((r(λ1)−r(λ2))/(r(λ3)−r(λ4))).

24. The sensor according to claim 22, wherein the testing device is configured to compare at least one of the ascertained diffuse reflectance values (r(λi), r(λ0)) and/or at least one second characteristic value (r(λ0), |r(λ3)−r(λ4)|), which is derived from at least some of the ascertained diffuse reflectance values, with at least one predetermined second comparison characteristic value (S0, S1).

25. The sensor according to claim 16, wherein in order to ascertain whether a reflective security element with an appearance that depends on the viewing angle is situated on the valuable document at the respective location, the testing device is configured to ascertain a distance between the diffuse reflectance spectrum obtained for the respective location and at least one predetermined reference spectrum and to test whether the ascertained distance is less than a predetermined comparison distance.

26. The sensor according to claim 16, wherein in order to ascertain whether a reflective security element with an appearance that depends on the viewing angle is situated on the valuable document at the respective location, the testing device is configured to ascertain a difference between the diffuse reflectance spectrum obtained for the respective location and a comparison spectrum that has been fitted to the diffuse reflectance spectrum and to test whether the ascertained difference is less than a predetermined comparison difference, the comparison spectrum given by a linear combination of at least two predetermined reference spectra.

27. The sensor according to claim 16, wherein the testing device is configured to consider only those locations in the valuable document test for which a respective diffuse reflectance spectrum was obtained that satisfies at least one of the following conditions:
the diffuse reflectance spectrum curve is not constant and/or has a predetermined minimum difference from a constant curve, and/or
the difference between a maximum and a minimum of the diffuse reflectance spectrum is greater than a predetermined minimum difference.

28. The sensor according to claim 16, wherein in order to ascertain whether a reflective security element with an appearance that depends on the viewing angle is situated on the valuable document at the respective location, the testing device is configured to form a derivative curve by differentiating the diffuse reflectance spectrum obtained for the respective location and to test whether the derivative curve is located within a predetermined tolerance range and/or has a difference from a predetermined target derivative curve that is less than a predetermined maximum distance.

29. The sensor according to claim 16, wherein in order to ascertain whether a reflective security element with an appearance that depends on the viewing angle is situated on the valuable document at the respective location, the testing device is configured to ascertain the wavelengths of two or more local extrema, of at least one local maximum (“max”) and at least one local minimum (“min”), in the diffuse reflectance spectrum obtained for the respective location and to test whether the ascertained wavelengths are located within wavelength intervals that are predetermined for the respective extrema and/or whether there is in each case only one local extremum within a wavelength interval that is predetermined for the respective extremum.

30. A method for testing valuable documents comprising at least one reflective security element that in the visible spectral range has an appearance that depends on a viewing angle, including the following steps:
irradiating one or more different locations on a valuable document with infrared radiation and capturing, with spectral resolution, the infrared radiation diffusely reflected from the respective location on the valuable document, with a diffuse reflectance spectrum being obtained in each case,
using the diffuse reflectance spectrum obtained for the respective location to ascertain whether a reflective security element with an appearance that depends on the viewing angle is situated on the valuable document at the respective location in order to ascertain one or more locations at which such a reflective security element is situated on the valuable document, and
testing the valuable document on the basis of the ascertained location or locations.
